(19) United States
(12) Patent Application Publication
(10) Pub. No.: US 2026/0149479 A1
(43) Pub. Date: May 28, 2026

(54) POWER LEAKAGE MITIGATION IN TRANSMIT DIVERSITY

(71) Applicant: QUALCOMM Incorporated, San Diego, CA (US)

(72) Inventors: Yongsheng OUYANG, Shanghai Shi (CN); Cheng TAN, Denver, CO (US); Sean Vincent MASCHUE, Encinitas, CA (US); Lei SUN, Irvine, CA (US); Guibing GU, Shanghai (CN)

(21) Appl. No.: 19/123,508

(22) PCT Filed: Dec. 29, 2022
(86) PCT No.: PCT/CN2022/143189

§ 371 Date: Apr. 23, 2025

(51) Int. Cl. H04B 1/525; H04B 1/401; H04B 1/44; H04B 3/32

(52) U.S. Cl. CPC H04B 1/525; H04B 1/401; H04B 1/44; H04B 3/32

(57) ABSTRACT

Certain aspects of the present disclosure provide techniques and apparatus for power leakage mitigation in transmit diversity. A method of controlling transmit diversity includes detecting that a first compensator among a plurality of compensators is 2024/138489 in transmit mode; outputting a first control signal to the first compensator to enable the first compensator for transmit mode in response to detecting that the first compensator is in transmit mode; and outputting a second control signal to a second compensator among the plurality of compensators to disable the second compensator from operating in transmit mode in response to detecting that the first compensator is in transmit mode.

### BACKGROUND

### Field of the Disclosure

Aspects of the present disclosure relate to wireless communications, and more particularly, to techniques for transmit diversity.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides an apparatus for wireless communication. The apparatus includes a logic circuit configured to: detect that a first compensator among a plurality of compensators is in transmit mode, output a first control signal to the first compensator to enable the first compensator for transmit mode in response to detecting that the first compensator is in transmit mode, and output a second control signal to a second compensator among the plurality of compensators to disable the second compensator from operating in transmit mode in response to detecting that the first compensator is in transmit mode.

One aspect provides an apparatus. The apparatus includes a transceiver circuit comprising a power amplifier. The apparatus further includes a first compensator circuit coupled between the transceiver circuit and a first antenna and a second compensator circuit coupled between the transceiver circuit and a second antenna. The apparatus further includes a first AND logic circuit having an output coupled to the first compensator and having a first input coupled to a first control signal line and a second input coupled to a second control signal line; a second AND logic circuit having an output coupled to the second compensator and having a first input coupled to the first control signal line; and an inverter logic circuit having an output coupled to a second input of the second AND logic circuit and an input coupled to the second control signal line.

One aspect provides a method of controlling transmit diversity. The method includes detecting that a first compensator among a plurality of compensators is in transmit mode; outputting a first control signal to the first compensator to enable the first compensator for transmit mode in response to detecting that the first compensator is in transmit mode; and outputting a second control signal to a second compensator among the plurality of compensators to disable the second compensator from operating in transmit mode in response to detecting that the first compensator is in transmit mode.

One aspect provide an apparatus. The apparatus includes means for detecting that a first compensator among a plurality of compensators is in transmit mode; means for outputting a first control signal to the first compensator to enable the first compensator for transmit mode in response to detecting that the first compensator is in transmit mode; and means for outputting a second control signal to a second compensator among the plurality of compensators to disable the second compensator from operating in transmit mode in response to detecting that the first compensator is in transmit mode.

One aspect provides a computer-readable medium having instructions stored thereon for detecting that a first compensator among a plurality of compensators is in transmit mode; outputting a first control signal to the first compensator to enable the first compensator for transmit mode in response to detecting that the first compensator is in transmit mode; and outputting a second control signal to a second compensator among the plurality of compensators to disable the second compensator from operating in transmit mode in response to detecting that the first compensator is in transmit mode.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A and FIG. 5B show diagrammatic representations of example vehicle to everything (V2X) systems.

FIG. 6 is a schematic diagram illustrating an example network of multiple V2X devices communicating with each other.

FIG. 7 illustrates a diagram of an example cellular V2X device having transmit diversity.

FIG. 8 is a block diagram of an example RF transceiver circuit.

FIG. 9 illustrates a diagram of an example transceiver architecture implementing transmit power leakage mitigation.

FIG. 10 illustrates a timing diagram of example signals associated with enabling and disabling the compensators as depicted in FIG. 9.

FIG. 11 depicts aspects of an example communications device.

### DETAILED DESCRIPTION

Aspects of the present disclosure provide apparatuses, methods, processing systems, and computer-readable mediums for mitigating power leakage in transmit diversity.

In certain wireless communication architectures (e.g., a transceiver architecture in a vehicle or roadside unit for cellular vehicle-to-everything (CV2X) communications), switched transmit diversity may be used to switch between different transmit antennas arranged in different positions when transmitting radio frequency (RF) signals. As an example, a vehicle (or roadside unit) may be equipped with a first antenna arranged at the front of the vehicle and a second antenna arranged at the back of the vehicle, and in some cases more antennas may be arranged across the vehicle or roadside unit. The transmit diversity may enable the vehicle to effectively emit RF signals omnidirectionally around the vehicle. The omnidirectional coverage provided by the antenna diversity may enable the vehicle or roadside unit to communicate with other vehicles or devices in any direction. In an effort to improve reliability of a transmission, retransmissions may be output with transmit diversity. For example, the first antenna may be used to transmit an RF signal in a first transmission occasion, and the second antenna may be used to transmit the RF signal as a re-transmission in a second transmission occasion.

As the antennas may be remotely located from a transceiver in a vehicle or roadside unit, the RF cables that couple the transceiver to the antennas may have a pathloss (e.g., a cable loss or power loss). To compensate for this pathloss in the RF cable, a compensator may be coupled between the transceiver and the antenna. As an example, the compensator may amplify (or attenuate) an RF signal received at the antenna or for transmission at the antenna. In some cases, an RF signal to be transmitted at one antenna may leak into a compensator coupled to another antenna, and the compensator may amplify such electrical leakage. The amplified leakage from the compensator may result in self-interference or a weak distorted RF signal being emitted at the other antenna. Such leakage being emitted at an antenna may degrade the performance of wireless transmissions.

Aspects of the present disclosure provide apparatus and methods for mitigating power leakage in transmit diversity. A transceiver may indicate to compensators when to be enabled or disabled for transmit signal compensation. A control signal may be provided to a compensator to indicate whether the compensator is enabled or disabled for transmit mode. As an example, a logic circuit may detect that a particular compensator is enabled for transmit mode. The logic circuit may output a control signal indicating to enable a compensator for transmit mode and output another control signal indicating to disable another compensator for transmit mode. In certain aspects, the transceiver architecture described herein may be implemented for sidelink communications, V2X communications, and/or CV2X communications.

The power leakage mitigation described herein may enable improved wireless communication performance, such as enhanced data rates, reduced latency, increased reliability, increased coverage, etc. The power leakage mitigation described herein may prevent RF signal leakage into another compensator, preventing an interfering transmission or weak, distorted signal from being emitted by an antenna. Such mitigation may allow for RF signals to be transmitted at a particular antenna without leakage being emitted from another antenna.

Example sidelink communications include V2X communications and/or CV2X. Though certain aspects may be discussed with respect to V2X (or CV2X) communications in a V2X communications system, it should be noted that the aspects may equally apply to other suitable types of sidelink communications systems. In certain aspects, such communications may occur in an unlicensed spectrum (shared spectrum) or a licensed spectrum. An unlicensed spectrum (or shared spectrum) refers to any frequency band(s) that are not subject to licensed use under regulatory or standardized practice, such that the frequency band(s) are open to use by any wireless communication device, and not merely devices that have permission from a license holder to use the particular frequency band(s).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

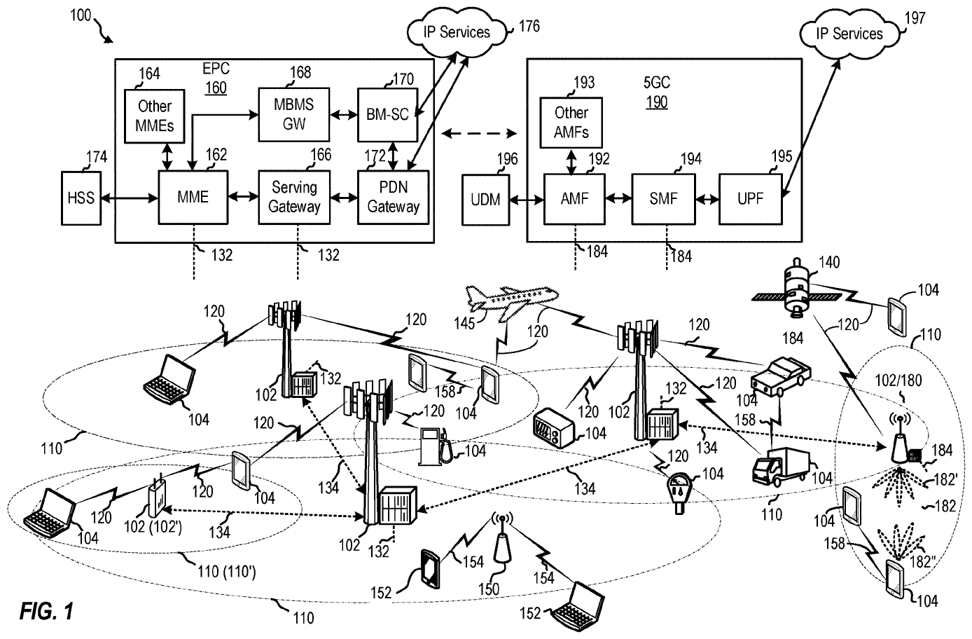

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

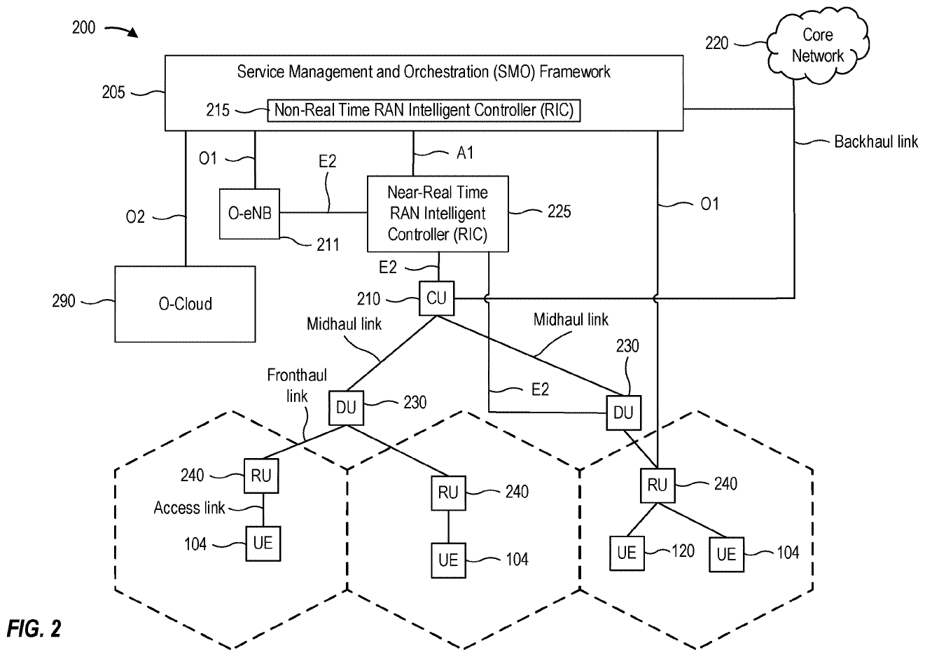

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5 GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1(FR 1) as including 410 MHz-7125 MHz, which is often referred to (interchangeably) as “Sub-6 GHz”. Similarly, 3 GPP currently defines Frequency Range 2(FR 2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR 2 -2 including 52,600 MHz-71,000 MHz. A base station configured to communicate using mmWave/near mm Wave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

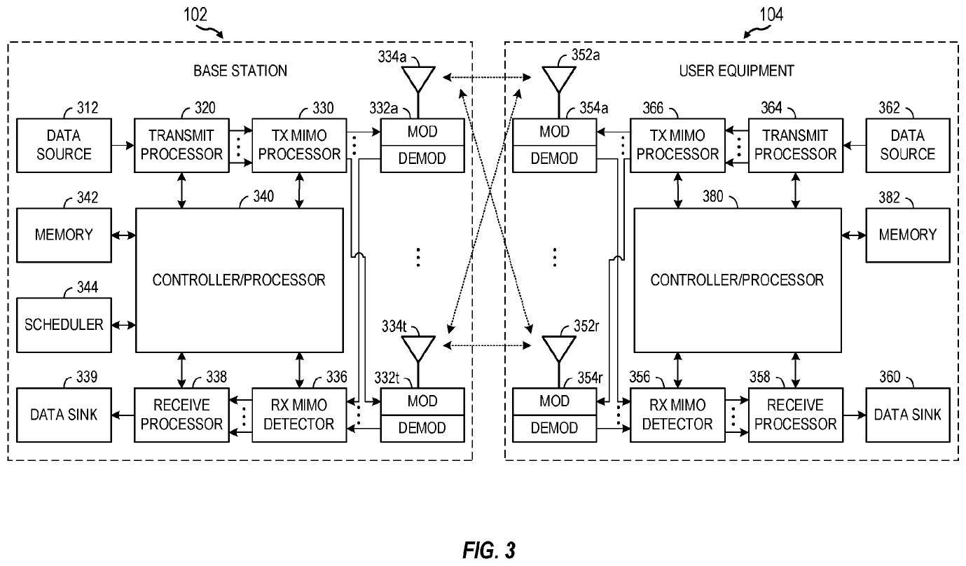

FIG. 3 depicts aspects of an example BS 102 and a UE 104. Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

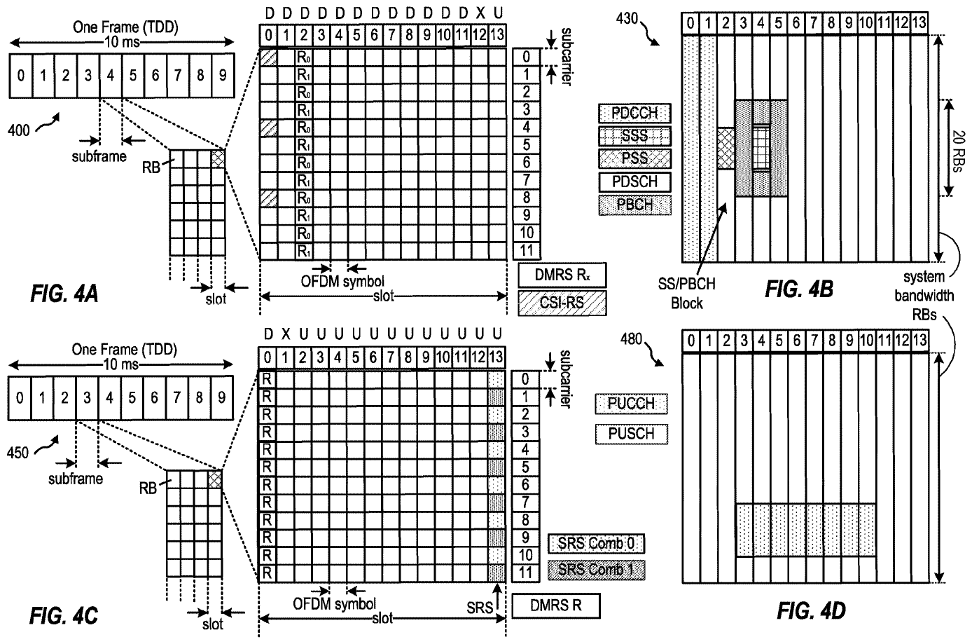

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example V2X Communications

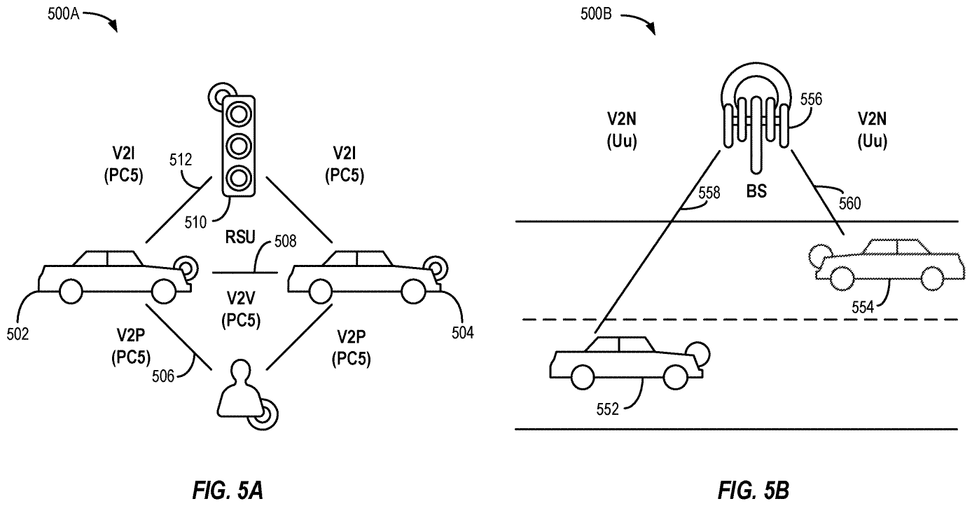

FIG. 5A and FIG. 5B show diagrammatic representations of example vehicle-to-everything (V2X) systems, in accordance with some aspects of the present disclosure. For example, the vehicles shown in FIG. 5A and FIG. 5B may communicate via sidelink channels and may relay sidelink transmissions as described herein.

The V2X systems provided in FIG. 5A and FIG. 5B provide two complementary transmission modes. A first transmission mode (also referred to as mode 4), shown by way of example in FIG. 5A, involves direct communications (for example, also referred to as sidelink communications) between participants in proximity to one another in a local area. A second transmission mode (also referred to as mode 3), shown by way of example in FIG. 5B, involves network communications through a network, which may be implemented over a Uu interface (for example, a wireless communication interface between a radio access network (RAN) and a UE).

Referring to FIG. 5A, a V2X system 500 (for example, including vehicle-to-vehicle (V2V) communications) is illustrated with two vehicles 502, 504. The first transmission mode allows for direct communication between different participants in a given geographic location. As illustrated, a vehicle can have a wireless communication link 506 with an individual (V2P) (for example, via a UE) through a PC5 interface. Communications between the vehicles 502 and 504 may also occur through a PC5 interface 508. In a like manner, communication may occur from a vehicle 502 to a roadside unit (RSU) 510, such as a traffic signal or sign (V2I) through a PC5 interface 512. With respect to each communication link illustrated in FIG. 5A, two-way communication may take place between elements, therefore each element may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus, in certain aspects, any vehicle with an equipped system may access a common frequency and share information.

FIG. 5B shows a V2X system 500B for communication between a vehicle 552 and a vehicle 554 through a network entity 556. These network communications may occur through discrete nodes, such as a BS (e.g., the BS 102), that sends and receives information to and from (for example, relays information between) vehicles 552, 554. The network communications through vehicle to network (V2N) links 558 and 560 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QOS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

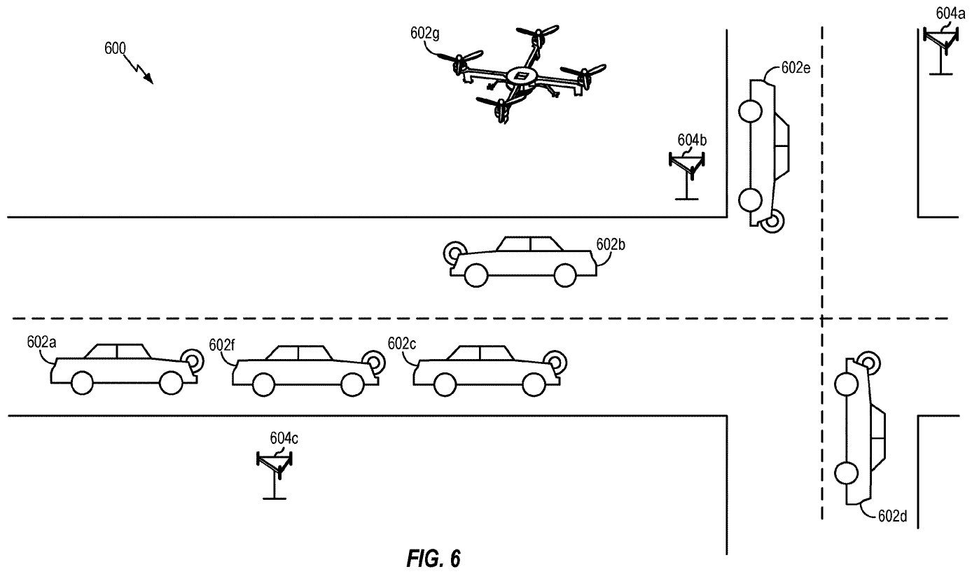

FIG. 6 is a schematic diagram illustrating an example network 600 of multiple CV2X devices operating in an unlicensed spectrum (shared spectrum) or a licensed spectrum. The unlicensed spectrum may be an example of a sidelink frequency band. Further, the network 600 may be an example of a sidelink communication system. The CV2X devices 602 may be configured to communicate on sidelink frequency channels as discussed herein. For example, any of the CV2X devices 602 may communicate with any other of the CV2X devices 602.

In the illustrated example, seven CV2X devices (e.g., a first CV2X device 602a, a second CV2X device 602b, a third CV2X device 602c, a fourth CV2X device 602d, a fifth CV2X device 602e, a sixth CV2X device 602f, and a seventh CV2X device 602g)—collectively referred to as CV2X devices 602) may operate in an unlicensed spectrum with other non-CV2X devices (e.g., non-CV2X devices 604a-c—collectively referred to as non-CV2X devices 604). In some examples, the first CV2X device 602a, the sixth CV2X device 602f, and the third CV2X device 602c may be part of a fleet or platoon. In transportation, platooning or flocking is a method for driving a group of vehicles together. It is meant to increase the capacity of roads via an automated highway system. Platoons decrease the distances between cars or trucks, such as based on sidelink communications.

Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 602 may include UEs (e.g., UE 104 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter. The CV2X devices 602 may include UEs (e.g., UE 104 of FIG. 1), and may be devices implemented on motorized vehicles (such as an automobile, motorcycle, truck, etc.) or carried by users (e.g., pedestrian, bicyclist, etc.), or implemented as a roadside unit.

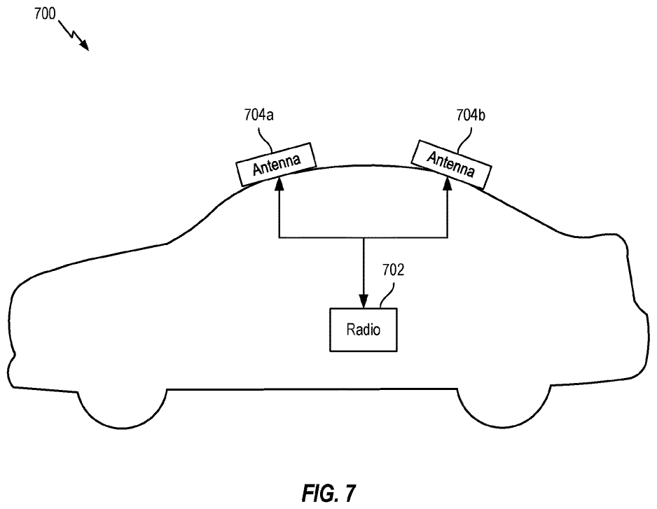

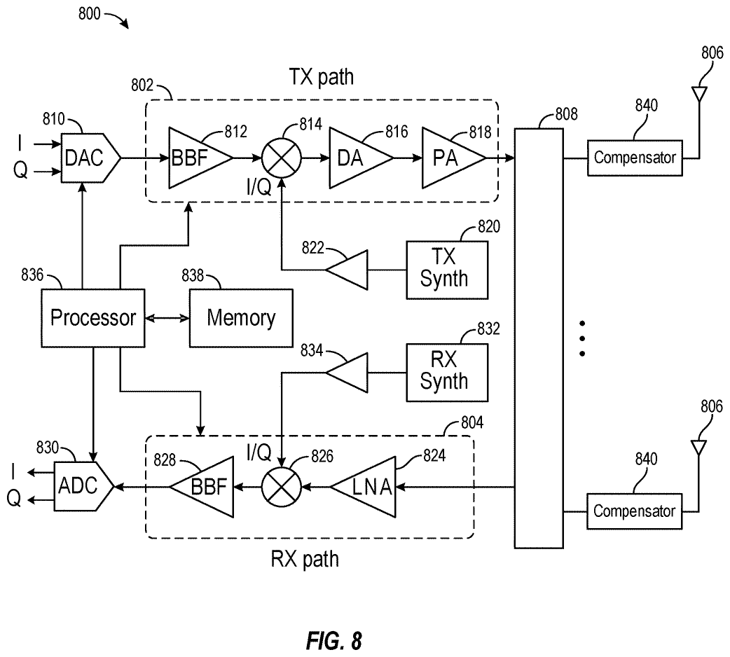

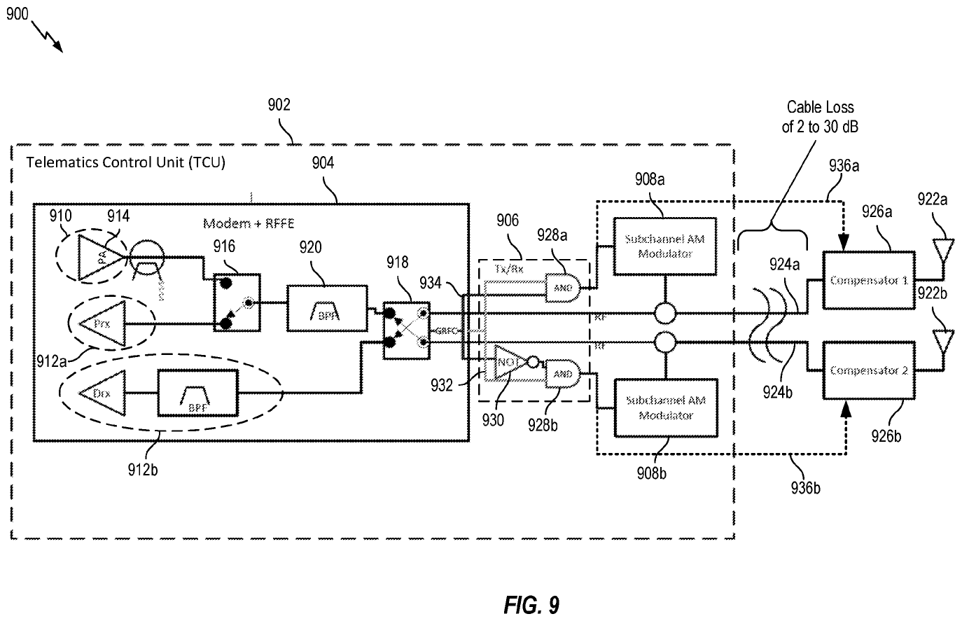

In certain aspects, a CV2X device may wirelessly communicate using transmit diversity (TXD), such as switched transmit diversity (TXD). As an example, FIG. 7 illustrates a diagram of an example CV2X device 700 having a radio 702 coupled to different antennas 704a, 704b. The radio 702 may include a processor, a modem, and a transceiver circuit (not shown) as described herein with respect to FIG. 3 and as further described herein with respect to FIGS. 8 and 9. The first antenna 704a may be arranged near or in the front of the CV2X device 700, and the second antenna 704b may be arranged near or in the back of the CV2X device 700. The antennas 704a, 704b may be arranged remotely from the radio 702, and compensators (not shown) may be used as further described herein to compensate for path losses in RF cables coupling the radio 702 to the antennas 704a, 704b. In certain aspects, the CV2X device 700 may transmit from the antennas 704a, 704b separately over time. For example, the first antenna 704a may be used to transmit an RF signal in a first transmission occasion, and the second antenna 704b may be used to transmit the RF signal (for example, as a retransmission) in a second transmission occasion that does not coincide with (e.g., overlap with) the first transmission occasion in time. The radio 702 may switch between using the first antenna 704a and the second antenna 704b for transmitting signals. The transmit diversity may provide omnidirectional RF coverage for the CV2X device 700 to communicate with other devices, such as the CV2X devices 602.

### Example RF Transceiver

FIG. 8 is a block diagram of an example RF transceiver circuit 800. The RF transceiver circuit 800 includes at least one transmit (TX) path 802 (also known as a transmit chain) for transmitting signals via one or more antennas 806 and at least one receive (RX) path 804 (also known as a receive chain) for receiving signals via the antennas 806. When the TX path 802 and the RX path 804 share an antenna 806, the paths may be connected with the antenna via an interface 808, which may include any of various suitable RF devices, such as a switch, a duplexer, a diplexer, a multiplexer, and the like.

Receiving in-phase (I) or quadrature (Q) baseband analog signals from a digital-to-analog converter (DAC) 810, the TX path 802 may include a baseband filter (BBF) 812, a mixer 814, a driver amplifier (DA) 816, and a power amplifier (PA) 818. The BBF 812, the mixer 814, and the DA 816 may be included in one or more radio frequency integrated circuits (RFICs). The PA 818 may be external to the RFIC(s) for some implementations.

The BBF 812 filters the baseband signals received from the DAC 810, and the mixer 814 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the beat frequencies. The beat frequencies are typically in the RF range, such that the signals output by the mixer 814 are typically RF signals, which may be amplified by the DA 816 and/or by the PA 818 before transmission by the antenna 806. While one mixer 814 is illustrated, several mixers may be used to upconvert the filtered baseband signals to one or more intermediate frequencies and to thereafter upconvert the intermediate frequency signals to a frequency for transmission.

The RX path 804 may include a low noise amplifier (LNA) 824, a mixer 826, and a baseband filter (BBF) 828. The LNA 824, the mixer 826, and the BBF 828 may be included in one or more RFICs, which may or may not be the same RFIC that includes the components of the TX path 802. RF signals received via the antenna 806 may be amplified by the LNA 824, and the mixer 826 mixes the amplified RF signals with a receive local oscillator (LO) signal to convert the RF signal of interest to a different baseband frequency (e.g., downconvert). The baseband signals output by the mixer 826 may be filtered by the BBF 828 before being converted by an analog-to-digital converter (ADC) 830 to digital I or Q signals for digital signal processing.

Certain transceivers may employ frequency synthesizers with a voltage-controlled oscillator (VCO) to generate a stable, tunable LO frequency with a particular tuning range. Thus, the transmit LO frequency may be produced by a TX frequency synthesizer 820, which may be buffered or amplified by amplifier 822 before being mixed with the baseband signals in the mixer 814. Similarly, the receive LO frequency may be produced by an RX frequency synthesizer 832, which may be buffered or amplified by amplifier 834 before being mixed with the RF signals in the mixer 826.

In certain aspects, a compensator 840 may be coupled between the TX path 802 or RX path 804 and the antenna 806. The compensator 840 may amplify (or attenuate or filter) an RF signal output by the TX path 802 or received by the antenna 806 to compensate for a pathloss of an RF cable (not shown) between the TX path 802 or the RX path 804 and the antenna 806. In some cases, the compensator 840 may cancel out (or at least reduce) cable loss in the transmit and receive directions. As the TX path 802 and/or RX path 804 may not take into account the cable loss (which may vary from one type of vehicle to another, depending on cable length, for example), the compensator 840 may be designed to measure the cable loss and cancel out this cable loss (referred to as “gain neutral”).

A processor 836 may control the operation of the RF transceiver circuit 800. For example, the processor 836 may control a switch (not shown) to selectively couple particular antenna(s) to the TX path 802 and/or RX path 804 and/or control a gain applied to the TX path 802 and/or 804. The processor 836 may include a modem (e.g., the modulator and/or demodulator of transceiver 354), a digital signal processor (DSP), an application specific integrated circuit (ASIC), a field programmable gate array (FPGA) or other programmable logic device (PLD), discrete gate or transistor logic, discrete hardware components, or any combination thereof. The memory 838 may store data and program codes for operating the RF transceiver circuit 800. In some cases, the processor 836 and/or memory 838 may include control logic.

### Aspects Related to Leakage Power Mitigation in Transmit Diversity

Aspects of the present disclosure provide apparatus and methods for mitigating power leakage in transmit diversity. A transceiver may indicate to compensators when to be enabled or disabled for transmit signal compensation. A control signal may be provided to a compensator to indicate whether the compensator is enabled or disabled for transmit mode. As an example, a logic circuit may detect that a particular compensator is enabled for transmit mode. The logic circuit may output a control signal indicating to enable a compensator for transmit mode and output another control signal indicating to disable another compensator for transmit mode. In certain aspects, the transceiver architecture described herein may be implemented for sidelink communications, V2X communications, and/or CV2X communications.

The power leakage mitigation described herein may enable improved wireless communication performance, such as enhanced data rates, reduced latency, increased reliability, increased coverage, etc. The power leakage mitigation described herein may prevent RF signal leakage into another compensator, preventing an interfering transmission or weak, distorted signal from being emitted by an antenna. Such mitigation may allow for RF signals to be transmitted at a particular antenna without leakage from being emitted from other antennas.

FIG. 9 illustrates a diagram of an example transceiver architecture 900 for certain wireless communications, such as sidelink communications or CV2X communications in a shared spectrum and/or licensed spectrum. In this example, the transceiver architecture 900 may perform switched transmit diversity, for example, as described herein with respect to FIG. 7. The transceiver architecture 900 may be integrated, in one example, in a vehicle or a roadside unit (e.g., vehicles 502, 504, 552, 554; the CV2X devices 602; and/or RSU 510).

The transceiver architecture 900 may include a telematics control unit (TCU) 902 that may perform any of various telematic functions, such as wireless communications (e.g., sidelink communications, V2X communications, and/or CV2X communications), satellite navigation, wireless vehicle safety communications, etc. The TCU 902 may include a portion of an RF transceiver circuit as described herein with respect to FIG. 8. The TCU 902 may include a transceiver circuit 904, a logic circuit 906, and subchannel amplitude modulation (AM) modulators 908a, 908b. In certain aspects, the TCU 902 may include one or more circuits, such as integrated circuit(s) or circuit(s) formed on printed circuit board(s). The TCU 902 may be representative of various circuit boards and/or integrated circuits. In certain cases, the TCU 902 may be distributed among multiple circuit packages, circuit modules, circuit boards, and/or integrated circuits in communication with each other, where the various packages, modules, circuit boards, and/or integrated circuits may be remotely located from each other. In some cases, the TCU 902 may be representative of a single package or module of various circuits.

The transceiver circuit 904 may include a modem and an RF front end (RFFE), for example as described herein with respect to FIG. 8. In some cases, the transceiver circuit 904 may include the RFFE and the modem integrated in a circuit package. The transceiver circuit 904 may communicate via any of various radio access technologies, such as 2G or 3G (e.g., a Universal Mobile Telecommunications System (UMTS)), 4G (e.g., Evolved Universal Terrestrial Radio Access (E-UTRA)), 5G (e.g., NR), IEEE 802.11, Bluetooth, and/or any future wireless wide area network (WWAN) or wireless local area network (WLAN) communication standard.

The transceiver circuit 904 may have a TX path 910, a first RX path 912a (e.g., a primary receive (Prx) path), and a second RX path 912b (e.g., a diversity receive (Drx) path). The TX path 910 and RX path 912a, 912b may include any of the components described herein with respect to FIG. 8. For example, the TX path 910 may include a power amplifier 914 (e.g., the PA 818) that outputs an RF signal to a first switch 916. The first switch 916 may selectively couple either the TX path 910 or the first RX path 912 to a second switch 918, which may selectively couple either of a first antenna 922a (e.g., the first antenna 704a) or a second antenna 922b (e.g., the second antenna 704b) to the first switch 916. A filter 920 may be coupled between the first switch 916 and the second switch 918, where the filter 920 may include a bandpass filter, for example. The second switch 918 may include a double pole, double throw (DPDT) switch, for example. The second switch 918 may be coupled to each of the subchannel AM modulators 908a, 908b via separate signal paths.

The subchannel AM modulators 908a, 908b may modulate the RF signal output by the TX path 910 or received by the antennas 922a, 922b with another carrier frequency (e.g., 125 MHz) and output the modulated RF signal to RF cables 924 a, 924 b, respectively. The RF cables 924a, 924b may be coaxial cables, for example. The RF cables 924a, 924b may be coupled between the TCU 902 and compensators 926a, 926b (e.g., the compensators 840). The RF cables 924 a, 924 b may have a cable loss of 2 to 30 decibels (dB). The compensators 926a, 926b may be coupled to the respective antenna 922a, 922b.

In certain aspects, the transceiver circuit 904 may transmit via a single antenna at a time using switched transmit diversity. In some cases, transmit power for one antenna may leak over to another antenna, where the transmit power leakage may trigger the respective compensator to amplify a distorted, weak RF signal without transmit power leakage mitigation. For example, transmit power may leak over the signal path associated with the first antenna 922a via the second switch 918 and/or the RF cables 924a, 924b.

To mitigate or prevent the transmit power leakage, the logic circuit 906 detects when a particular antenna is being used for transmission and disables the compensator(s) for the other antenna(s). For example, the logic circuit 906 obtains an indication that a particular antenna is in transmit mode, and in response to the detection, the logic circuit 906 outputs certain control signals enabling the compensator for the particular antenna and disabling the compensator(s) for the other antenna(s).

The logic circuit 906 may include a first AND logic circuit 928a (e.g., an AND gate) having an output coupled to the first compensator 926a and having a first input coupled to a first control signal line 932 and a second input coupled to a second control signal line 934. The logic circuit 906 may include a second AND logic circuit 928b having an output coupled to the second compensator 926b and having a first input coupled to the first control signal line 932. The logic circuit 906 may include an inverter logic circuit 930 having an output coupled to a second input of the second AND logic circuit 928b and an input coupled to the second control signal line 934.

The control signal lines 932, 934 may be controlled and/or output by a processor or modem, such as the processor 836. Each of the control signal lines 932, 934 may be a programmable output of the transceiver circuit 904, such as a general-purpose input-output (GPIO) pin or a programmable digital signal pin that at least outputs a digital signal.

The first control signal line 932 may indicate whether the transceiver circuit 904 is in transmit mode or receive mode. In some cases, the first control signal line 932 may carry the control signal applied to the first switch 914 (or mimic such a control signal). For example, a first digital state (e.g., a digital high state) of the first control signal line 932 may indicate that the transceiver circuit 904 is in transmit mode, and a second digital state (e.g., a digital low state, of the first control signal line 932 may indicate that the transceiver circuit 904 is in receive mode. In transmit mode, the first switch 916 may be selectively coupled to the TX path 910 and selectively decoupled from the first RX path 912a.

The second control signal line 934 may be coupled to or representative of a general RF control (GRFC) output pin of the transceiver circuit 904, where the GRFC output pin may be a general-purpose programmable digital output pin. The second control signal line 934 may indicate which compensator is enabled for transmission. For example, a first digital state of the second control signal line 934 (e.g., a digital high state) may indicate that the first compensator 926a is enabled for transmission, and a second digital state (e.g., a digital low state) of the second control signal line 934 may indicate that the second compensator 926a is enabled for transmission. In some cases, the second control signal line 934 may carry the control signal (e.g., the DPDT control signal) applied to the second switch 918 (or mimic such a control signal).

In certain cases, the transceiver circuit 904 may only have a certain number of output pins to communicate with the compensators 926a, 926b. For example, the transceiver circuit 904 may only have the two control signal lines 932, 934 to disable or enable the compensators 926a, 926b for transmit mode via the logic circuit 906.

As an example, if the control signal lines 932, 934 are both high, the first AND logic circuit 928a may output a control signal indicating to enable the first compensator 926a for transmit mode, and the second AND logic circuit 928b may output a control signal indicating to disable the second compensator 926b for transmit mode. As another example, if the first control signal line 932 is high, and if the second control signal line 934 is low, the first AND logic circuit 928a may output a control signal indicating to disable the first compensator 926a, and the second AND logic circuit 928b may output a control signal indicating to enable the second compensator 926b. When a particular compensator is disabled from operating in transmit mode, the compensator may refrain from performing the cable loss cancellation (or other signal processing) on RF signals output by the transceiver circuit 904. When a particular compensator is enabled for operating in transmit mode, the compensator may perform the cable loss cancellation (or other signal processing) on RF signals output by the transceiver circuit 904.

In certain cases, the logic circuit 906 may have outputs (e.g., the outputs of the AND logic circuits 928a, 928b) coupled to the respective subchannel AM modulators 908a, 908b. Each of the subchannel AM modulators 908a, 908b may modulate the digital control signal and multiplex the modulated signal with the respective RF signal output to the respective compensator 926a, 926b. For example, the first AND logic circuit 928a may output a control signal to the first subchannel AM modulator 908a, which may modulate the control signal and multiplex the modulated signal with the RF signal or any transmit power leakage. The first compensator 926a may decode or demodulate the modulated control signal and determine whether the first compensator 926a is enabled or disabled for transmit mode based on the control signal. Such an approach to communicating with a compensator may be used when the compensator lacks a general input pin to control the compensator or when a general input pin is unavailable, for example.

In some cases, the logic circuit 906 may output the control signals to the compensators via a third control signal line 936a coupled to the first compensator 926a and a fourth control signal line 936b coupled to the second compensator 926b. For example, the first AND logic circuit 928a may output a control signal to the first compensator 926a via the third control signal line 936a.

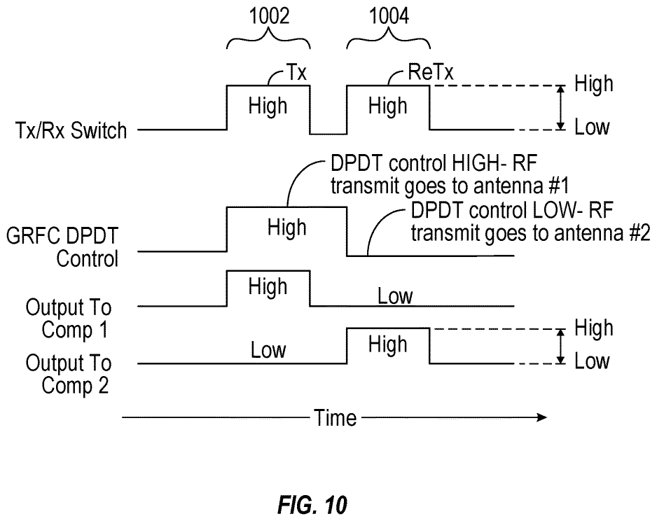

FIG. 10 illustrates a timing diagram of example signals associated with enabling and disabling the compensators 926a, 926b as depicted in FIG. 9. In a first transmission occasion 1002, the transceiver circuit 904 may output a first RF signal (not shown) for transmission via the first antenna 922a. During the first transmission occasion 1002, the first control signal line 932 (e.g., TX/RX Switch signal) and the second control signal line 934 (e.g., GRFC DPDT control signal) may be high. The first AND logic circuit 928a may output a control signal (e.g., output to Comp 1) that is high indicating to the first compensator 926a to be enabled for transmit mode, and the second AND logic circuit 928b may output a control signal (e.g., output to Comp 2) that is low indicating to the second compensator 926b to be disabled for transmit mode.

In a second transmission occasion 1004, the transceiver circuit 904 may output a second RF signal for transmission via the second antenna 922b (in some examples, the second RF signal may be a re-transmission of the first RF signal). During the second transmission occasion 1004, the first control signal line 932 (e.g., TX/RX Switch signal) may be high, whereas the second control signal line 934 (e.g., GRFC DPDT control signal) may be low. The first AND logic circuit 928a may output a control signal (e.g., output to Comp 1) that is low indicating to the first compensator 926a to be disabled for transmit mode, and the second AND logic circuit 928b may output a control signal (e.g., output to Comp 2) that is high indicating to the second compensator 926b to enabled for transmit mode.

It will be appreciated that the transmit power leakage mitigation described herein with respect to FIGS. 9 and 10 are merely examples. Aspects of the present disclosure may also be implemented using separate control signals to each of the compensators from the transceiver circuit, where each of the control signals is dedicated to indicating whether a particular compensator is enabled or disabled for transmit mode. Aspects of the present disclosure may be implemented using a single compensator or two or more compensators. In some cases, the logic circuit may be implemented as a multiplexer and/or a switch coupled to a plurality of compensators.

### Example Communications Devices

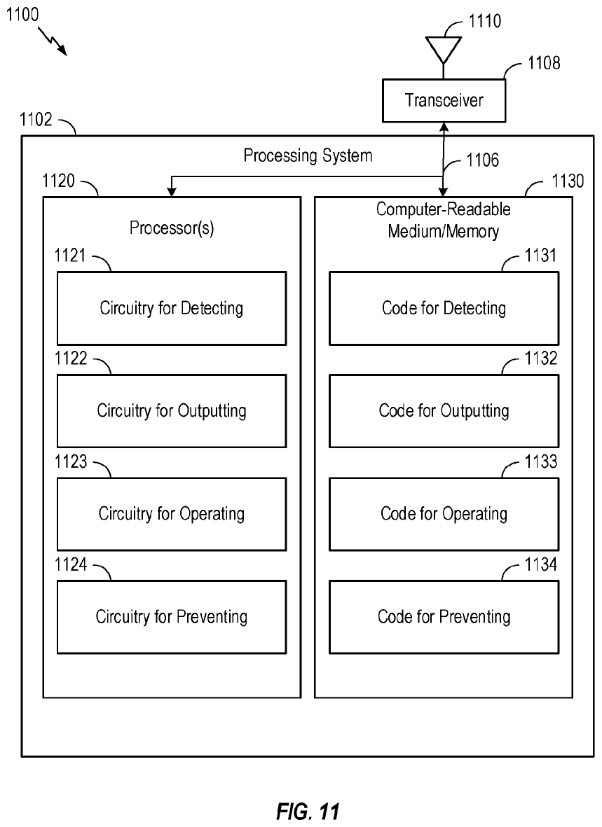

FIG. 11 depicts aspects of an example communications device 1100. In some aspects, communications device 1100 is a user equipment, such as UE 104 described above with respect to FIGS. 1 and 3.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 358, transmit processor 364, TX MIMO processor 366, and/or controller/processor 380, as described with respect to FIG. 3. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform transmit power leakage mitigation described herein, or any aspect related to it. Note that reference to a processor performing a function of communications device 1100 may include one or more processors performing that function of communications device 1100.

In the depicted example, computer-readable medium/memory 1130 stores code (e.g., executable instructions) for detecting 1131, code for outputting 1132, code for operating 1133, code for preventing 1134, or any combination thereof. Processing of the code 1131-1134 may cause the communications device 1100 to perform transmit power leakage mitigation described herein, or any aspect related to it.

The one or more processors 1120 include circuitry configured to implement (e.g., execute) the code stored in the computer-readable medium/memory 1130, including circuitry for detecting 1121, circuitry for outputting 1122, circuitry for operating 1123, circuitry for preventing 1124, or any combination thereof. Processing with circuitry 1121-1124 may cause the communications device 1100 to perform the transmit power leakage mitigation described herein, or any aspect related to it.

Various components of the communications device 1100 may provide means for performing the transmit power mitigation described herein, or any aspect related to it. For example, means for transmitting, sending or outputting for transmission may include the transceivers 354 and/or antenna(s) 352 of the UE 104 illustrated in FIG. 3 and/or transceiver 1108 and antenna 1110 of the communications device 1100 in FIG. 11. Means for receiving or obtaining may include the transceivers 354 and/or antenna(s) 352 of the UE 104 illustrated in FIG. 3 and/or transceiver 1108 and antenna 1110 of the communications device 1100 in FIG. 11. Means for outputting may include the transceiver circuit 904 and/or the logic circuit 906 of FIG. 9. Means for detecting may include the logic circuit 906 of FIG. 9. Means for operating and means for preventing may include the compensators 926a, 926b.

### Example Clauses

Implementation examples are described in the following numbered clauses:

Aspect 1: An apparatus for wireless communication, comprising: a logic circuit configured to: detect that a first compensator among a plurality of compensators is in transmit mode, output a first control signal to the first compensator to enable the first compensator for transmit mode in response to detecting that the first compensator is in transmit mode, and output a second control signal to a second compensator among the plurality of compensators to disable the second compensator from operating in transmit mode in response to detecting that the first compensator is in transmit mode.

Aspect 2: The apparatus of Aspect 1, further comprising a radio frequency (RF) transceiver circuit configured to generate a first signal for transmission via the first compensator.

Aspect 3: The apparatus of Aspect 1 or 2, further comprising: a memory; and a processor coupled to the memory, the processor being configured to output a first indication to indicate the first compensator is in transmit mode, wherein the logic circuit is coupled to the processor and configured to detect that the first compensator is in transmit mode based on the first indication.

Aspect 4: The apparatus of Aspect 3, wherein the first indication comprises a second indication indicating to operate at least one of the compensators in transmit mode and a third indication indicating a particular compensator among the plurality of compensators.

Aspect 5: The apparatus of Aspect 3 or 4, wherein the logic circuit comprises: a first AND logic circuit having inputs coupled to the processor; an inverter logic circuit having an input coupled to the processor; and a second AND logic circuit having a first input coupled to an output of the inverter logic circuit and a second input coupled to the processor.

Aspect 6: The apparatus of Aspect 5, further comprising: a first modulator configured to multiplex the first control signal with the first signal onto a first signal path coupled to the first compensator, wherein the first AND logic has an output coupled to the first modulator; and a second modulator configured to multiplex the second control signal onto a second signal path coupled to the second compensator, wherein the second AND logic circuit has an output coupled to the second modulator.

Aspect 7: The apparatus of Aspect 5, wherein: the first AND logic circuit has an output coupled to the first compensator; and the second AND logic circuit has an output coupled to the second compensator.

Aspect 8: The apparatus according to any of Aspect 3-7, wherein: the processor is further configured to output a second indication to indicate the second compensator is in transmit mode; wherein the logic circuit is further configured to: detect that the second compensator is in transmit mode based on the second indication, output a third control signal to the second compensator to enable the second compensator for transmit mode in response to detecting that the second compensator is in transmit mode, output a fourth control signal to the first compensator to disable the first compensator from operating in transmit mode in response to detecting that the second compensator is in transmit mode; the RF transceiver circuit is configured to output a second signal for transmission via the second compensator; and the first compensator is configured to refrain from operating in transmit mode in response to obtaining the fourth control signal.

Aspect 9: The apparatus according to any of Aspects 3-8, further comprising: a first antenna coupled to the RF transceiver circuit; and a second antenna coupled to the RF transceiver circuit.

Aspect 10: The apparatus of Aspect 9, wherein the first antenna, the second antenna, the first compensator, and the second compensator are physically positioned closer to a exterior portion of a device relative to a physical location of the RF transceiver circuit.

Aspect 11: The apparatus according to any of Aspects 2-10, wherein the RF transceiver circuit is configured to communicate via cellular vehicle-to-everything (CV2X) communications.

Aspect 12: A method of controlling transmit diversity, comprising: detecting that a first compensator among a plurality of compensators is in transmit mode; outputting a first control signal to the first compensator to enable the first compensator for transmit mode in response to detecting that the first compensator is in transmit mode; and outputting a second control signal to a second compensator among the plurality of compensators to disable the second compensator from operating in transmit mode in response to detecting that the first compensator is in transmit mode.

Aspect 13: The method of Aspect 12, further comprising: operating the first compensator in transmit mode in response to obtaining the first control signal at the first compensator; preventing the second compensator from operating in transmit mode in response to obtaining the second control signal at the second compensator.

Aspect 14: The method of Aspect 12 or 13, further comprising: outputting a first indication to indicate the first compensator is in transmit mode, wherein detecting that the first compensator is in transmit mode comprises detecting that the first compensator is in transmit mode based on the first indication; and outputting a first signal for transmission via the first compensator.

Aspect 15: The method of Aspect 14, wherein the first indication comprises a second indication indicating to operate at least one of the compensators in transmit mode and a third indication indicating a particular compensator among the plurality of compensators.

Aspect 16: The method of Aspect 14 or 15, wherein detecting that the first compensator is in transmit mode comprises detecting that the first compensator is in transmit mode if the first indication indicates to operate at least one of the compensators in transmit mode and if the first indication indicates the first compensator.

Aspect 17: The method according to any of Aspects 12-16, wherein detecting that the first compensator is in transmit mode comprises detecting that the first compensator is in transmit mode via a logic circuit.

Aspect 18: The method according to any of Aspects 12-17, wherein outputting the first control signal comprises outputting the first control signal via an AND logic circuit coupled to the first compensator.

Aspect 19: The method according to any of Aspects 12-18, wherein outputting the second control signal comprises outputting the second control signal via an AND logic circuit coupled to the second compensator and an inverter logic circuit coupled to an input of the AND logic circuit.

Aspect 20: The method according to any of Aspects 12-19, further comprising: outputting a second indication to indicate the second compensator is in transmit mode; detecting the second compensator is in transmit mode based on the second indication; outputting a third control signal to the second compensator to enable the second compensator for transmit mode in response to detecting that the second compensator is in transmit mode; outputting a fourth control signal to the first compensator to disable the first compensator from operating in transmit mode in response to detecting that the second compensator is in transmit mode; outputting a second signal for transmission via the second compensator; and preventing the first compensator from operating in transmit mode in response to obtaining the fourth control signal at the first compensator.

Aspect 21: An apparatus, comprising: a transceiver circuit comprising a power amplifier; a first compensator circuit coupled between the transceiver circuit and a first antenna; a second compensator circuit coupled between the transceiver circuit and a second antenna; a first AND logic circuit having an output coupled to the first compensator and having a first input coupled to a first control signal line and a second input coupled to a second control signal line; a second AND logic circuit having an output coupled to the second compensator and having a first input coupled to the first control signal line; and an inverter logic circuit having an output coupled to a second input of the second AND logic circuit and an input coupled to the second control signal line.

Aspect 22: The apparatus of Aspect 21, wherein the first control signal line is configured for a tx/rx switch control signal and wherein the second control signal line is configured to receive a RF control signal.

Aspect 23: The apparatus of Aspect 21 or 22, wherein the transceiver circuit is configured to selectively output an RF signal to the first compensator circuit and the second compensator circuit.

Aspect 24: The apparatus according to any of Aspects 21-23, wherein the first antenna, the second antenna, the first compensator, and the second compensator are physically positioned closer to a exterior portion of a device relative to a physical location of the transceiver circuit.

Aspect 25: The apparatus according to any of Aspects 21-24, wherein the first antenna, the second antenna, the first compensator, and the second compensator are physically positioned closer to a exterior portion of a vehicle relative to a physical location of the transceiver circuit within the vehicle.

Aspect 26: The apparatus according to any of Aspects 21-25, wherein the first antenna, the second antenna, the first compensator, and the second compensator are integrated in a vehicle.

Aspect 27: The apparatus of Aspect 26, wherein the transceiver circuit is part of a telematic control unit.

Aspect 28: The apparatus according to any of Aspects 21-26, wherein the transceiver circuit is part of a telematic control unit.

Aspect 29: The apparatus according to any of Aspects 21-28, further comprising: a first modulator coupled to the output of the first AND logic circuit and coupled to an input of the first compensator; and a second modulator coupled to the output of the second AND logic circuit and coupled to an input of the second compensator.

Aspect 30: The apparatus of Aspect 29, wherein the first modulator is configured to multiplex a first control signal onto an RF signal provided to the input of the first compensator, and wherein the second modulator is configured to multiplex a second control signal onto the RF signal provided to the input of the second compensator.

Aspect 31: An apparatus, comprising: a memory comprising computer-executable instructions; and one or more processors configured to execute the computer-executable instructions and cause the apparatus to perform a method in accordance with any of Aspects 12-20.

Aspect 32: An apparatus, comprising means for performing a method in accordance with any of Aspects 12-20.

Aspect 33: A non-transitory computer-readable medium comprising computer-executable instructions that, when executed by one or more processors of a processing system, cause the processing system to perform a method in accordance with any of Aspects 12-20.

Aspect 34: A computer program product embodied on a computer-readable storage medium comprising code for performing a method in accordance with any of Aspects 12-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising:
a logic circuit configured to:
detect that a first compensator among a plurality of compensators is in transmit mode,
output a first control signal to the first compensator to enable the first compensator for transmit mode in response to detecting that the first compensator is in transmit mode, and
output a second control signal to a second compensator among the plurality of compensators to disable the second compensator from operating in transmit mode in response to detecting that the first compensator is in transmit mode.

2. The apparatus of claim 1, further comprising a radio frequency (RF) transceiver circuit configured to generate a first signal for transmission via the first compensator.

3. The apparatus of claim 2, further comprising:
a memory; and
a processor coupled to the memory, the processor being configured to output a first indication to indicate the first compensator is in transmit mode,
wherein the logic circuit is coupled to the processor and configured to detect that the first compensator is in transmit mode based on the first indication.

4. The apparatus of claim 3, wherein the first indication comprises a second indication indicating to operate at least one of the compensators in transmit mode and a third indication indicating a particular compensator among the plurality of compensators.

5. The apparatus of claim 3, wherein the logic circuit comprises:
a first AND logic circuit having inputs coupled to the processor;
an inverter logic circuit having an input coupled to the processor; and
a second AND logic circuit having a first input coupled to an output of the inverter logic circuit and a second input coupled to the processor.

6. The apparatus of claim 5, further comprising:
a first modulator configured to multiplex the first control signal with the first signal onto a first signal path coupled to the first compensator, wherein the first AND logic has an output coupled to the first modulator; and
a second modulator configured to multiplex the second control signal onto a second signal path coupled to the second compensator, wherein the second AND logic circuit has an output coupled to the second modulator.

7. The apparatus of claim 5, wherein:
the first AND logic circuit has an output coupled to the first compensator; and
the second AND logic circuit has an output coupled to the second compensator.

8. The apparatus of claim 3, wherein:
the processor is further configured to output a second indication to indicate the second compensator is in transmit mode;
wherein the logic circuit is further configured to:
detect that the second compensator is in transmit mode based on the second indication,
output a third control signal to the second compensator to enable the second compensator for transmit mode in response to detecting that the second compensator is in transmit mode,
output a fourth control signal to the first compensator to disable the first compensator from operating in transmit mode in response to detecting that the second compensator is in transmit mode;
the RF transceiver circuit is configured to output a second signal for transmission via the second compensator; and
the first compensator is configured to refrain from operating in transmit mode in response to obtaining the fourth control signal.

9. The apparatus of claim 3, further comprising:
a first antenna coupled to the RF transceiver circuit; and
a second antenna coupled to the RF transceiver circuit.

10. The apparatus of claim 9, wherein the first antenna, the second antenna, the first compensator, and the second compensator are physically positioned closer to a exterior portion of a device relative to a physical location of the RF transceiver circuit.

11. The apparatus of claim 2, wherein the RF transceiver circuit is configured to communicate via cellular vehicle-to-everything (CV2X) communications.

12. A method of controlling transmit diversity, comprising:
detecting that a first compensator among a plurality of compensators is in transmit mode;
outputting a first control signal to the first compensator to enable the first compensator for transmit mode in response to detecting that the first compensator is in transmit mode; and
outputting a second control signal to a second compensator among the plurality of compensators to disable the second compensator from operating in transmit mode in response to detecting that the first compensator is in transmit mode.

13. The method of claim 12, further comprising:
operating the first compensator in transmit mode in response to obtaining the first control signal at the first compensator;
preventing the second compensator from operating in transmit mode in response to obtaining the second control signal at the second compensator.

14. The method of claim 12, further comprising:
outputting a first indication to indicate the first compensator is in transmit mode, wherein detecting that the first compensator is in transmit mode comprises detecting that the first compensator is in transmit mode based on the first indication; and
outputting a first signal for transmission via the first compensator.

15-20. (canceled)

21. An apparatus, comprising:
a transceiver circuit comprising a power amplifier;
a first compensator circuit coupled between the transceiver circuit and a first antenna;
a second compensator circuit coupled between the transceiver circuit and a second antenna;
a first AND logic circuit having an output coupled to the first compensator and having a first input coupled to a first control signal line and a second input coupled to a second control signal line;
a second AND logic circuit having an output coupled to the second compensator and having a first input coupled to the first control signal line; and
an inverter logic circuit having an output coupled to a second input of the second AND logic circuit and an input coupled to the second control signal line.

22. The apparatus of claim 21, wherein the first control signal line is configured for a tx/rx switch control signal and wherein the second control signal line is configured to receive a RF control signal.

23. The apparatus of claim 21, wherein the transceiver circuit is configured to selectively output an RF signal to the first compensator circuit and the second compensator circuit.

24. The apparatus of claim 21, wherein the first antenna, the second antenna, the first compensator, and the second compensator are physically positioned closer to a exterior portion of a device relative to a physical location of the transceiver circuit.

25. The apparatus of claim 21, wherein the first antenna, the second antenna, the first compensator, and the second compensator are physically positioned closer to a exterior portion of a vehicle relative to a physical location of the transceiver circuit within the vehicle.

26. The apparatus of claim 21, wherein the first antenna, the second antenna, the first compensator, and the second compensator are integrated in a vehicle.

27-32. (canceled)
